(19) United States
(12) Patent Application Publication
(10) Pub. No.: US 2012/0098947 A1
(43) Pub. Date: Apr. 26, 2012

(54) Producing universally sharp images

(76) Inventor: David Robert Wilkes, Richmond Hill (CA)

(21) Appl. No.: 13/317,548

(22) Filed: Oct. 20, 2011

Related U.S. Application Data
(60) Provisional application No. 61/394,942, filed on Oct. 20, 2010.

(51) Int. Cl. H04N 5/228; H04N 7/18

(52) U.S. Cl. 348/65; 348/222.1; 348/79; 348/E05.031; 348/E07.085

(57) ABSTRACT

A method for producing an output image defined by output pixels comprises capturing a focus stack of input images, each input image defined by input pixels and having a resolution higher than the output image, determining a group of input pixels in each input image corresponding to one of the output pixels, calculating a figure of merit and a summary pixel value for each group of input pixels, and computing a value for each output pixel by mathematically combining the figures of merit and the summary pixel values corresponding to each output pixel. The output image values are calculated such that the entire output image is sharply in focus.

I claim priority to my provisional application No. 61/394,942.

### FIELD OF THE INVENTION

The present invention relates generally to image and video photography and in particular, to a method and system for producing a universally sharp image.

### BACKGROUND OF THE INVENTION

Under certain conditions, it is a challenge in the field of image and video photography to capture images in which the entire subject matter is sharply in focus. For example, in the field of endoscopy, images of human internal organs are captured and can contain pairs of regions which are at significantly different distances from the camera lens, exceeding its depth of focus. As a result, in the captured images, one of the regions will be out of focus. Another example is in the field of microscopy, where it is difficult to image three-dimensional specimens so that all portions of the specimen are in focus in the same image, given the extremely shallow depth of field of conventional microscope images.

Methods are known which combine images of a scene or single object, taken from similar viewpoints at varying focus settings (“focus stack”). The focus stack is used to estimate an output image which contains more parts of the scene in sharp focus than any individual input image from the focus stack.

In the field of microscopy, images in the focus stack are acquired using a scan along one dimension (1D), using a 1D-array of light-sensitive elements to capture image data at successive scan positions in a direction perpendicular to the 1D sensor array, such as that described in U.S. Pat. Nos. 7,706,632, 5,394,205, and 5,248,876. The focus stack is acquired similarly in the field of document or image reproduction, such as that described in U.S. Pat. Nos. 6,201,619 and 5,446,276.

It is well known in the art to use a telecentric lens assembly so that pixels in various images in the focus stack are directly interchangeable with each other, with respect to their coverage of the object being imaged. U.S. Patent Application Publication No. 2005/0100245 addresses distortions between images in a focus stack due to a non-telecentric lens assembly and due to misalignment between the direction of focus change and the optical axis of the lens system. Although this method corrects distortions, it requires a dense focus stack, that is, a focus stack having only small changes in focus from one image to the next, and demands a high computational load for each output image computed.

U.S. Pat. No. 5,248,876 describes a system used to acquire the entire focus stack in a single scan, without requiring sensor motion in any direction other than the 1D scan direction, using a particular arrangement of apertures in a confocal microscope to provide constrained imaging and lighting conditions, along with a tilted specimen stage. The need for sufficient integration time at each scan position makes real-time, dynamic image capture difficult for the system and the system by definition requires structured, artificial illumination, limiting its usefulness in non-microscopic applications.

There exists public domain software for creation of sharp images from focus stacks, used for example in non-patent reference [Goldsmith, “Deep Focus: A Digital Image Processing Technique to Produce Improved Focal Depth in Light Microscopy,” Image Anal Stereol 2000; 19:163-167]. However, such applications typically either assume a telecentric lens system has been used, or require computationally intensive steps to correct inter-image distortions on an ad hoc basis.

Another method of estimating the best focal distance for each output pixel position, that also provides independent estimates for each output pixel position, is described in non-patent reference “Omni-Focus Video Camera to Revolutionize Industry: Automatic Real-Time Focus of Both Near and Far Field Images,” ScienceDaily, University of Toronto, May 4, 2010. The described method uses explicitly-measured depth information, derived independently for each output pixel of a scene, using a technique described in U.S. Patent Application Publication No. 2010/0110165 to Iizuka, to choose from which input image to obtain the value of the output pixel. Although the described method performs better at occlusion boundaries, it is limited by the need for two independent, controllable point light sources illuminating the scene at wavelengths not already present in the environment, as ambient light in the scene interferes with the operation of the light sources. The working range of this technique is also limited by either the dynamic range of the cameras used to capture images or the focus range of the depth-recovery sensor itself While the above provide useful methods, improvements are of course desirable. It is therefore an object of the present invention to provide a novel method and system for producing a universally sharp image.

### SUMMARY OF THE INVENTION

Accordingly, in one aspect there is provided a method for producing an output image defined by output pixels comprising capturing a focus stack of input images, each input image defined by input pixels and having a resolution higher than the output image, determining a group of input pixels in each input image corresponding to one of the output pixels, calculating a figure of merit and a summary pixel value for each group of input pixels, and computing a value for each output pixel by mathematically combining the figures of merit and the summary pixel values corresponding to each output pixel.

In an embodiment, the capturing of the focus stack of input images is done using a two-dimensional (2D) array of light-sensitive elements, perpendicular to the optical axis, translated parallel to the optical axis to capture the individual images of the focus stack at successive times, using a high-speed drive such as a voice coil. This embodiment is used preferentially in imaging applications such as ordinary photography and videography.

In another embodiment, the capturing is done using a single, one-dimensional (1D) scan involving motion of a 2D array of light sensitive elements inclined at an angle different than 90 degrees to the optical axis, the scan being in a direction perpendicular to the optical axis of the lens assembly. As a consequence of the inclination of the sensor array, the scan captures scan lines concurrently for images at different focus settings, in a single pass. This method is used preferentially in applications where a 1D scan is typically used for image capture, such as document scanning or microscopy.

According to another aspect there is provided an imaging system comprising at least one imaging device having a plurality of focus settings, and a processing structure for receiving a focus stack of input images from the at least one imaging device, each input image defined by input pixels and having a resolution higher than the output image, the processing structure determining a group of input pixels in each input image corresponding to one of the output pixels, calculating a figure of merit and a summary pixel value for each group of input pixels, and computing a value for each output pixel by mathematically combining the figures of merit and the summary pixel values corresponding to each output pixel.

According to another aspect there is provided a computer readable medium embodying a computer program for producing an output image defined by output pixels, the computer program comprising program code for receiving a focus stack of input images from at least one imaging device, each input image defined by input pixels and having a resolution higher than the output image, program code for determining a group of input pixels in each input image corresponding to one of the output pixels, program code for calculating a figure of merit and a summary pixel value for each group of input pixels, and program code for computing a value for each output pixel by mathematically combining the figures of merit and the summary pixel values corresponding to each output pixel.

### BRIEF DESCRIPTION OF THE DRAWINGS

Embodiments will now be described more fully with reference to the accompanying drawings in which:

FIG. 1 is a flowchart showing a method of combining images to produce a universally sharp output image;

FIG. 2 is a schematic diagram of an exemplary imaging hardware setup, using a sensor perpendicular to the optical axis, on a high-speed drive;

FIG. 3 is flowchart showing a method for computing lookup tables for correspondences among pixels in the input images and the output image;

FIG. 4 is a diagram showing the geometry for determining pixel coordinates.

FIG. 5 is a flowchart showing a method for capturing a focus stack of input images using the apparatus of FIG. 2;

FIG. 6 is a flowchart showing a method for computing a sharpness figure of merit and summary pixel value for each input image group of pixels.

FIG. 7 is a schematic diagram of an alternate exemplary imaging hardware setup, using a sensor inclined with respect to the optical axis, for a 1D scan; and

FIG. 8 is a flowchart showing the alternate method for capturing a focus stack of input images using the apparatus of FIG. 7.

### DETAILED DESCRIPTION OF THE EMBODIMENTS

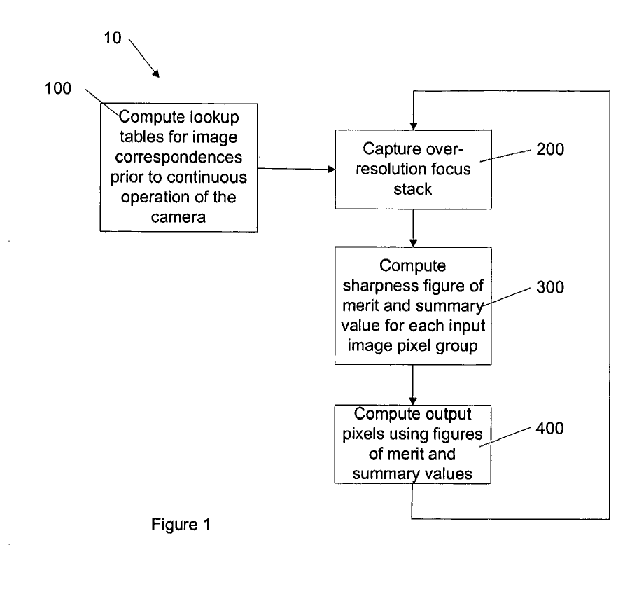

Turning now to FIG. 1, a flow chart showing a method of combining images to produce a universally sharp output image is shown and is generally identified by reference numeral 10. As will be discussed below, input images are captured and are defined by input pixels. The input images are captured at a higher resolution than the desired resolution of the output image. As such, a group of input pixels is identified as corresponding to each one of the output pixels. A universally sharp output image is made of output pixels each having an output pixel value that is sharply in focus.

Accordingly, method 10 begins with computing lookup tables for image correspondences between each output pixel and each group of input pixels (step 100). A focus stack of input images is captured using a focus stack capture program, wherein each input image has a different focus setting (step 200). A sharpness figure of merit and a summary pixel value are calculated for each group of input pixels (step 300). Each output pixel value is computed by mathematically combining the sharpness figures of merit and the summary pixel values (step 400) for the group of input pixels corresponding to the particular output pixel. In this embodiment, each output pixel value is calculated as the linear combination of each summary pixel value weighted by its respective sharpness figure of merit. As will be appreciated, the method of combining images to produce a universally sharp output image is carried out in conjunction with an imaging system, as will now be described.

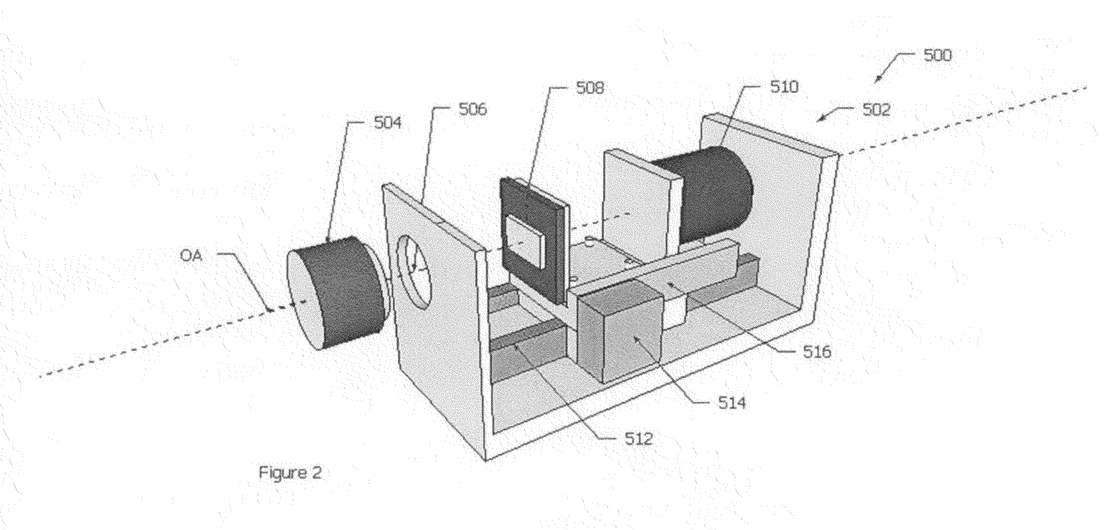

Turning now to FIG. 2, an exemplary imaging hardware system is shown and is generally identified by reference numeral 500. Imaging system 500 comprises imaging hardware 502. In this embodiment, imaging hardware 502 includes a commercially available lens assembly 504, having an internal focus setting locked at infinity. Lens assembly 504 is attached to the imaging hardware 502 with a C/CS lens mount 506. A board-level sensor array 508 is mounted within imaging hardware 502. The focus setting of system 500 is provided by linear motion of the sensor array 508, in a direction parallel to the optical axis OA of lens assembly 504. In this embodiment, the sensor array 508 is an iDS UI-1488LE-C digital board camera, providing USB 2.0 output of color image data at 2650×1920 pixel resolution. The linear motion is achieved by mounting the sensor array 508 on an H2WTech VCS10-023-BS-01 linear motion stage, comprising a voice coil actuator 510, linear bearings 512 and a control system (not shown) using 1-micron position feedback provided by a linear encoder 514 and moving scale 516. Data captured by the sensor array 508 is stored in the memory of a personal computer (not shown). The personal computer comprises computer readable instructions in the form of a focus stack capture program, which is configured to create a focus stack by storing an input image for each of a plurality of focus settings corresponding to different positions of the sensor array 508, the details of which will be discussed below.

The details of the method of combining images to produce a universally sharp output image will now be discussed. The following terms are defined to aid in the description of this embodiment:
Let H(x, y) be an output image defined by n×m output pixels. Thus, the red, green and blue pixel values at each position (x, y) in the output image are described by the 3-dimensional vector value H(x, y), for each pair (x, y)ε{(x, y)|0≦x<n, 0≦y<m}.
Let k be the number of input images in the focus stack.
Let F₀(x, y) be the first of k input images in the focus stack, defined by p×q input pixels such that the distance of sharp focus for F₀ is the largest required of the system. Thus, the red, green and blue pixel values at each position (x, y) in the output image are described by the 3-dimensional vector value F₀(x, y), for each pair (x, y)ε{(x, y)|0≦x<p, 0≦y<q}.
Let F₁(x, y) through Fₖ₋₁(x, y) be the remaining p×q pixel input images in the focus stack, with successively shorter distances of sharpest focus, and therefore successively longer distances between elements in the sensor array 508 and the lens assembly 504.

As one skilled in the art will appreciate, since each input image in the focus stack has a higher resolution than the output image, each pixel in the output image corresponds to a group of pixels in each input image. Accordingly, prior to image or video capture by imaging system 500, a lookup table is defined to correlate the input pixels in the input images to the output pixels in the output image. As will be appreciated, the use of non-telecentric lens assemblies, and misalignments of optical and mechanical components, may each lead to pixels with the same coordinates (x, y) in F₀(x, y), F₁(x, y), F₂(x, y), . . . corresponding to different portions of the imaged scene.

In meeting the objective of providing an efficient computation of the actual transformations among the image coordinate systems, a calibration step is performed prior to the real-time use of the system described herein. This calibration step reduces subsequent computations of pixel correspondences to simple table lookups. The actual pixel correspondences among the input images are computed by performing a calibration in which grids of points are imaged using hardware system 500. Each grid is set at a distance intermediate between the sharpest focus distances for two adjacent input images in the focus stack. The coordinates of each grid point in the two images serve to relate the image coordinate systems of the two images. In a particular embodiment, correspondences are achieved for all image pixel positions by expressing each pixel position as a linear combination of the positions of the three nearest, non-collinear grid points. This technique of linear combination uniquely identifies the position of each pixel in one image in terms of the coordinate system of the adjacent image. By repeating this technique using calibration grids for each pair of adjacent input images, a complete correspondence is obtained. As will be appreciated, the complete correspondence is insensitive to errors in the alignment of the optical axis of the lens assembly 504 with the axis of translation of the sensor array 508, changes in magnification with changing focal length, and a variety of other departures from alignment among corresponding pixels in successive images in the focus stack. The details of calculating the pixel correspondences will now be described.

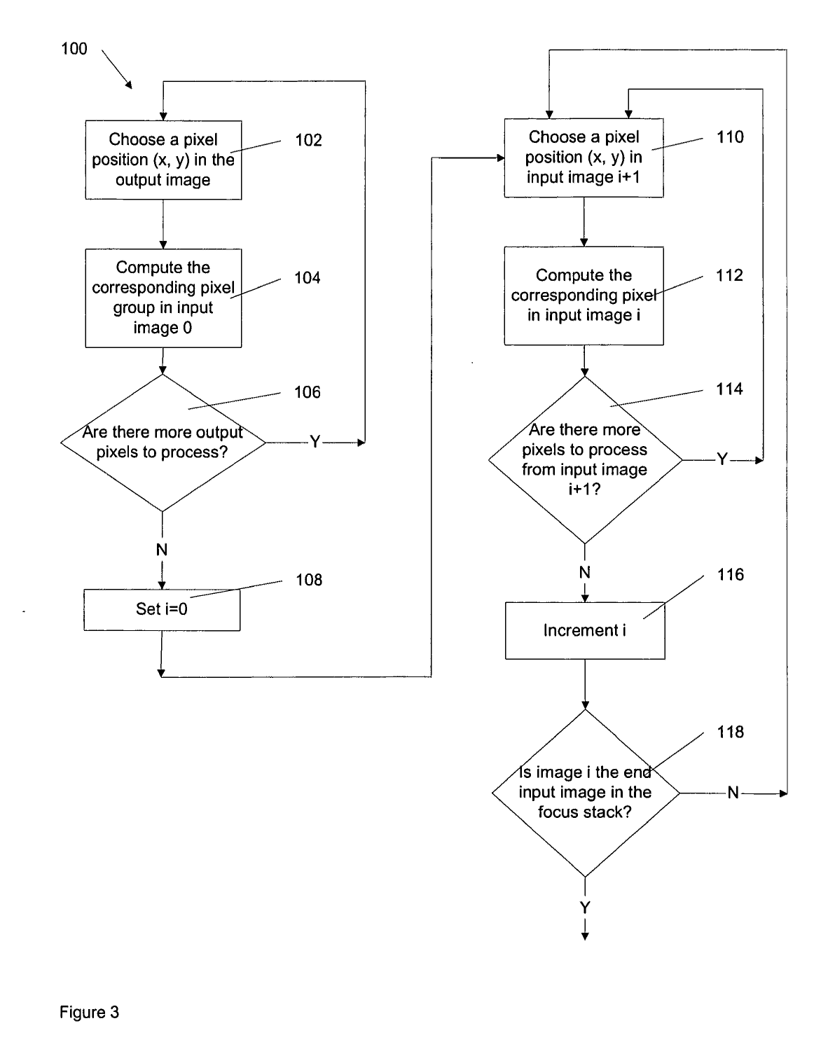

Turning now to FIG. 3, a flowchart showing the method 100 of computing lookup tables for correspondences between the output pixels and input pixels is shown. As can be seen, the method begins with choosing a particular output pixel in the output image H(x, y) with coordinates (x, y) (step 102). The first image F₀ from the input stack is examined and a group of input pixels h(x, y) in the first image F₀ is selected as corresponding to the particular output image pixel (step 104). This process continues for each output pixel in the output image H(x, y), until all output pixels are correlated with a group of input pixels h(x, y) from input image F₀(x, y) (step 106).

In this embodiment, the input pixel resolution p×q for each input image is 2560×1920. The desired output pixel resolution n×m is 640×480. Comparing the input pixel resolution to the desired output pixel resolution, it will be appreciated that there are 4×4 input pixels for every 1×1 output pixel. Accordingly, there are 16 pixels in each group of input pixels h(x, y) in input image F₀ corresponding to a particular output pixel. In this embodiment, the group of 16 input pixels h(x, y) for a particular output image pixel H(x, y) has the set of coordinate pairs:

$$h ( x , y ) = \{ ( 4 x , 4 y ) , ( 4 x , 4 y + 1 ) , ( 4 x , 4 y + 2 ) , ( 4 x , 4 y + 3 ) , ( 4 x + 1 , 4 y ) , ( 4 x + 1 , 4 y + 1 ) , ( 4 x + 1 , 4 y + 2 ) , ( 4 x + 1 , 4 y + 3 ) , ( 4 x + 2 , 4 y ) , ( 4 x + 2 , 4 y + 1 ) , ( 4 x + 2 , 4 y + 2 ) , ( 4 x + 2 , 4 y + 3 ) , ( 4 x + 3 , 4 y ) , ( 4 x + 3 , 4 y + 1 ) , ( 4 x + 3 , 4 y + 2 ) , ( 4 x + 3 , 4 y + 3 ) \}$$

Each input image F₀, F₁ . . . Fₖ in the focus stack is evaluated to correlate a group of input pixels in the input image with a particular output pixel. In order to achieve this, a counter variable i that increments as each input image in the focus stack is evaluated is maintained. The counter variable i is set to an initial value of 0 (step 108). Pixel coordinates (x′, y′) are chosen in input image Fᵢ₊₁ (step 110). A correspondence fᵢ(x, y) between pixel coordinates (x′, y′) in input image Fᵢ₊₁ and pixel coordinates (x, y) in input image Fᵢ is calculated (step 112), the details of which will be discussed below. The process continues until all pixels are processed in input image Fᵢ₊₁ (step 114). The method continues by incrementing the value of counter variable i (step 116) until the k-th image in the focus stack has been evaluated (step 118).

The correspondence vector function fᵢ(x, y) is determined by positioning a calibration target at a distance intermediate between the sharp focus distances for input images Fᵢ and Fᵢ₊₁. The calibration target consists of a grid of readily identifiable points, such as the corners of alternating white and black squares arranged in a checkerboard pattern, for which accurate image positions may be found using standard image processing techniques, known to those skilled in the art.

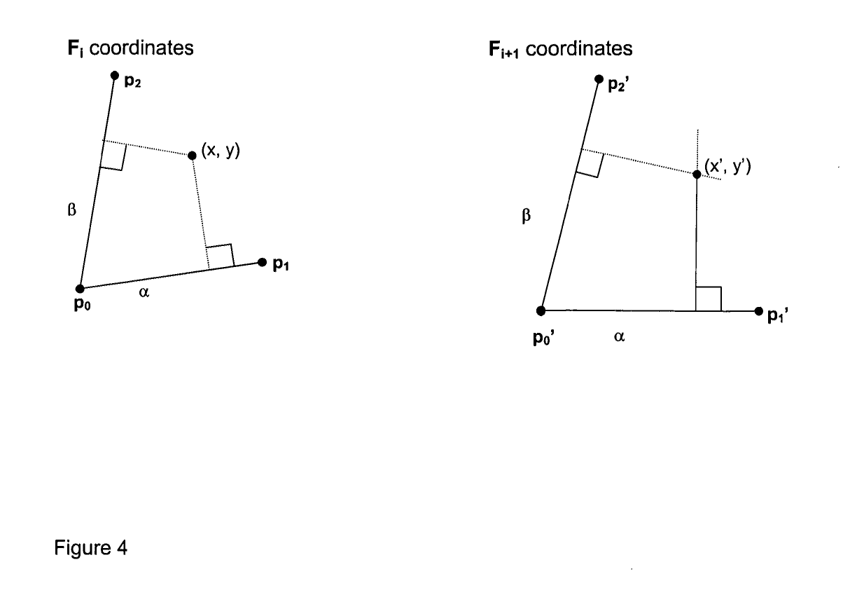

Turning now to FIG. 4, an exemplary geometrical setup to calculate the pixel coordinates (x′, y′) in input image Fᵢ₊₁ corresponding to pixel coordinates (x, y) in input image Fᵢ is shown. As can be seen, the three closest non-collinear calibration points p₀, p₁, and p₂ to pixel coordinates (x, y) of input image Fᵢ are used to define coordinates (α, β) defined by line segments p₀p₁ and p₀p₂. The locations of the same three calibration points are identified in input image Fᵢ₊₁ and are shown as p₀′, p₁′, and p₂′. The three calibration points p₀′, p₁′, and p₂′ and coordinates (α, β) are then used in the inverse transformation to calculate pixel coordinates (x′, y′).

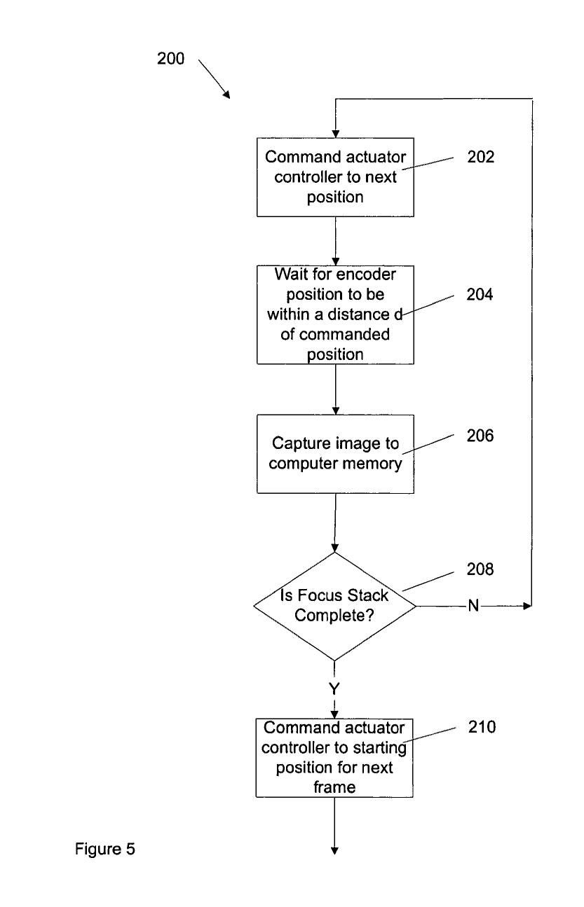

The details of an exemplary focus stack capture program will now be discussed. Turning to FIG. 5, the method 200 for capturing a focus stack of input images, using imaging system 500 is shown. As will be appreciated, the method may be used for capturing a single focus stack, from which a single, still output image may be created. The method may also be run repeatedly to produce successive focus stacks for output images which are frames in a video sequence. The method begins at step 202 where the control system of imaging hardware 500 commands the voice coil actuator 510 to move to the next position. The system waits for the linear encoder 514 to report a position within a threshold distance d of the commanded position (step 204). An image is then captured by the sensor array 508 and is stored to the memory of the personal computer (step 206). A check is then done by the control system to determine if the focus stack is complete (step 208). In the event that the focus stack is not complete, the process repeats until images have been captured at all commanded focus settings. In the event that the focus stack is complete, the control system commands the voice coil actuator 510 to move to the starting position and wait until commanded to capture the next image frame (step 210).

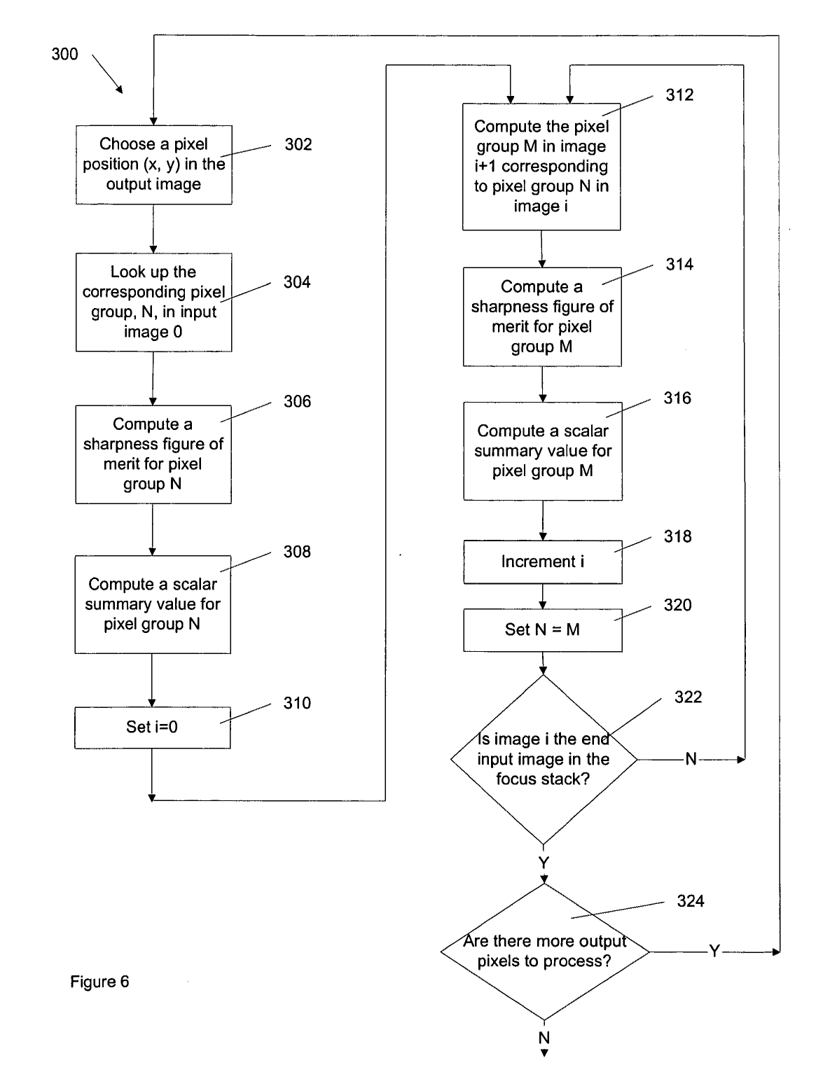

Turning now to FIG. 6, the method 300 for calculating a sharpness figure of merit and summary pixel value for each group of input pixels is shown. The method begins by choosing an output image pixel H(x, y) with coordinates (x, y) (step 302). The corresponding group of input pixels h(x, y) from input image F₀ is found using the lookup table defined by step 100 of FIG. 1 (step 304). A sharpness figure of merit is calculated for the group of input pixels h(x, y) by computing the maximum difference in magnitude for any of the RGB color components of each input pixel, over all input pixels in the group h(x, y) (step 306). The sharpness figure of merit is used to estimate the relative sharpness of focus of the group of input pixels h(x, y). The average of each of the red, green and blue input pixel values is calculated to provide a summary pixel value for the group of input pixels h(x, y) (step 308).

As will be appreciated, the above calculation must be performed over each image in the focus stack. Accordingly, counter variable i is incremented as each image in the focus stack is evaluated. Counter variable i is set to a value of 0 (step 310). A group of input pixels h′(x′, y′) from input image Fᵢ₊₁, with pixel coordinates (x′, y′) corresponding to the pixel coordinates (x, y) in input image Fᵢ, is calculated using the group of input pixels h(x, y) in input image Fᵢ and the correspondence fᵢ₊₁(x, y) (step 312). A sharpness figure of merit is calculated in step 314 for h′(x′, y′) in a similar manner to step 306. The average of each of the red, green and blue input pixel values is calculated to provide a summary pixel value for the group of input pixels h′(x′, y′) (step 316). Once input image Fᵢ₊₁ has been evaluated, counter variable i is incremented (step 318), and the group of input pixels h′(x, y) is set to h(x, y) (step 320). The process continues until the k-th image in the focus stack has been evaluated (step 322). The method then continues until all output pixels have been processed (step 324).

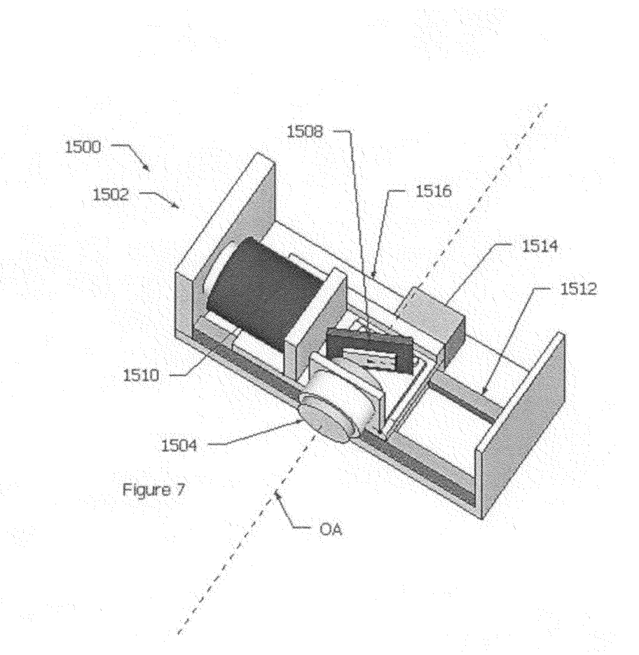

Turning now to FIG. 7, a further embodiment of the imaging hardware system is shown and is generally identified by reference numeral 1500. As can be seen, imaging hardware 1502 includes a commercially available lens assembly 1504, having an internal focus setting locked at a fixed value. Lens assembly 1504 is attached to imaging hardware 1502 with a C/CS lens mount (not labelled), similar to that of FIG. 2, however lens assembly 1504 is mounted in a fixed spatial relationship with the sensor array 1508. The sensor array 1508 is inclined with respect to the optical axis OA of the lens assembly 1504, at an angle different than 90 degrees with respect to the OA, but within the chief ray angle specification of the sensor array 1508. As will be understood by one skilled in the art, the sensor array 1508 is typically a back-illuminated sensor, with its surface layer of microlenses specified to allow incident rays at an angle of incidence significantly different than zero degrees. Each column of pixels in the sensor array 1508 serves the function of a 1D line sensor, for an image at an incrementally different focus setting than the neighboring columns, due to the inclination of the sensor array 1508, with each image being captured in parallel with the others in the focus stack as the sensor array 1508 is translated in one dimension by the voice coil 1510.

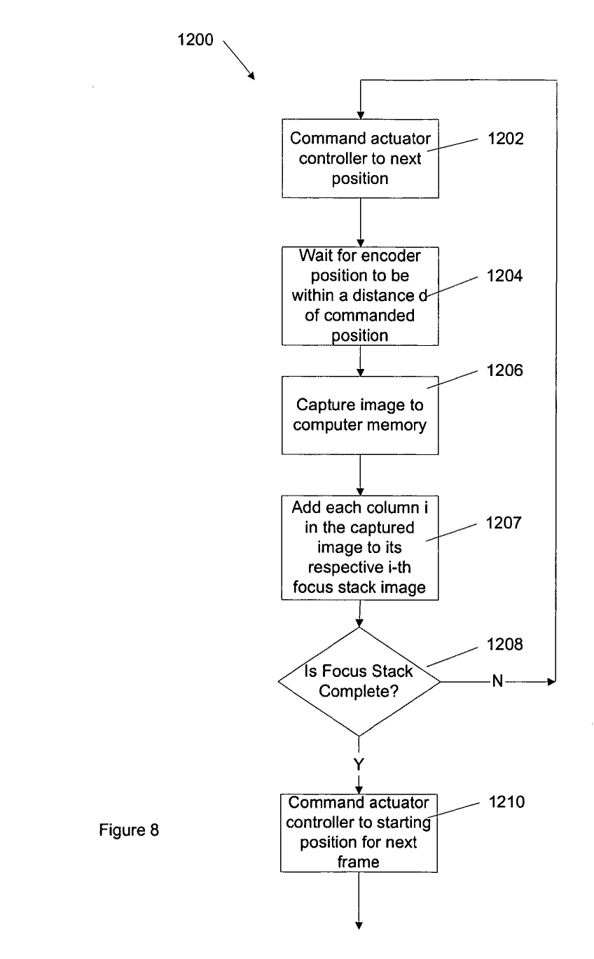

Turning now to FIG. 8, a method 1200 for capturing a focus stack of input images using imaging system 1500 is shown. Method 1200 is similar to method 200, but requires an additional step. In this additional step, each column i in the captured image is added to its respective i-th focus stack image (step 1207), with the number of focus stack images captured concurrently, and k being equal to the number of columns in the sensor array 1508.

The method for producing a universally sharp image was described as being executed in a particular sequence. For example, the focus stack was first captured, then the sharpness figure of merit and summary pixel value for each group of input pixels was calculated, and then the output pixel value was computed. However, those skilled in the art will appreciate that the method need not follow the same order described. For example, the sharpness figure of merit and summary pixel value may be calculated for every output pixel, prior to computing the output pixel value. Alternatively, the sharpness figure of merit and summary pixel value may be calculated for a single output pixel, and then that particular output pixel value calculated. In such an embodiment, the method would continue in a loop, calculating the sharpness figure of merit, summary pixel value, and output pixel value, pixel by pixel until the entire output image has been constructed.

Although particular embodiments of systems and methods were described for capturing a focus stack of input images, those skilled in the art will appreciate that alternatives are available. For example, a custom, back-illuminated sensor array including a top layer of microlenses or micromirrors optimized for capturing light with an incident angle corresponding exactly to that implied by the inclination of the sensor array, may be used as the sensor array 1508 in imaging system 1500. Further, mirrors, or a combination of mirrors and lenses, may be used as the focusing elements, in place of lens assembly 504. As another example, specialized, high-performance, digitally-controllable focusing elements, such as those disclosed in U.S. Pat. Nos. 7,072,086 and 6,344,930, may be used.

Although a particular method was described for determining the correspondences between input images in the focus stack, those skilled in the art will appreciate that other methods may be employed. For example, more than three nearest calibration points may be used to describe each pixel location, where an overspecified system would improve the accuracy of the correspondence. Also, simpler correspondence methods may be used if the full generality of the method described is not required, as in the case of a telecentric lens assembly 504.

Although the output image was constructed using a particular sharpness figure of merit for each group of input pixels, those skilled in the art will appreciate that other figures of merit may be used. For example, the relative magnitudes of discrete cosine transform coefficients within a band of spatial frequencies may be used.

Although each output pixel value was computed as the linear combination of the group of input pixels weighted by their sharpness figure of merit, the output pixel value may be calculated using other mathematical functions. For example, nonlinear combinations of groups of input pixels and their corresponding sharpness figures of merit may be used.

Although the system was described as saving each input image of the focus stack in the memory of the personal computer, those skilled in the art will appreciate that the entire input image need not be saved in the memory of the personal computer. For example, each group of input pixels corresponding to a particular output image could be replaced by the figure of merit for the group, and a representative output pixel value for the group. An example of a representative output pixel value for the group could be the average pixel value for the group.

Although embodiments have been described with reference to the drawings, those of skill in the art will appreciate that variations and modifications may be made without departing from the spirit and scope thereof as defined by the appended claims.

What is claimed is:

1. A method for producing an output image defined by output pixels comprising:
capturing a focus stack of input images, each input image defined by input pixels and having a resolution higher than the output image;
determining a group of input pixels in each input image corresponding to one of the output pixels;
calculating a figure of merit and a summary pixel value for each group of input pixels; and
computing a value for each output pixel by mathematically combining the figures of merit and the summary pixel values corresponding to each output pixel.

2. The method of claim 1 wherein the capturing comprises translating an image sensor along an optical axis.

3. The method of claim 1 wherein the capturing comprises translating an inclined image sensor transversely with respect to an optical axis.

4. The method of claim 1 wherein the capturing comprises changing a position of at least one optical element and an image sensor.

5. The method of claim 1 wherein the figure of merit is a sharpness figure of merit.

6. The method of claim 5 wherein the sharpness figure of merit is calculated as a maximum difference of an image property of the input pixels.

7. The method of claim 6 wherein the image property is a magnitude of a color component.

8. The method of claim 1 wherein the figure of merit is calculated as a coefficient of a discrete cosine transform of the group of input pixels.

9. The method of claim 1 wherein the value is computed as a linear combination of the figure of merit and the summary pixel value.

10. The method of claim 1 wherein the value is computed as a non-linear combination of the figure of merit and the summary pixel value.

11. The method of claim 1 wherein the input images are captured as still images.

12. The method of claim 1 wherein the input images are captured at a frame rate suitable for video applications.

13. The method of claim 1 wherein the capturing is executed by medical endoscopy equipment.

14. The method of claim 1 wherein the capturing is executed by microscopy equipment.

15. An imaging system comprising:
at least one imaging device having a plurality of focus settings; and
a processing structure for receiving a focus stack of input images from the at least one imaging device, each input image defined by input pixels and having a resolution higher than the output image, the processing structure determining a group of input pixels in each input image corresponding to one of the output pixels, calculating a figure of merit and a summary pixel value for each group of input pixels, and computing a value for each output pixel by mathematically combining the figures of merit and the summary pixel values corresponding to each output pixel.

16. A computer readable medium embodying a computer program for producing an output image defined by output pixels, the computer program comprising:
program code for receiving a focus stack of input images from at least one imaging device, each input image defined by input pixels and having a resolution higher than the output image;
program code for determining a group of input pixels in each input image corresponding to one of the output pixels;
program code for calculating a figure of merit and a summary pixel value for each group of input pixels; and
program code for computing a value for each output pixel by mathematically combining the figures of merit and the summary pixel values corresponding to each output pixel.
